(19) United States
(12) Patent Application Publication
(10) Pub. No.: US 2026/0310928 A1
(43) Pub. Date: Oct. 8, 2026

(54) INFORMATION PROCESSING APPARATUS, INFORMATION PROCESSING METHOD, AND PROGRAM

(71) Applicant: SOFTBANK CORP., Tokyo (JP)

(72) Inventor: Yuko ISHIWAKA, Tokyo (JP)

(21) Appl. No.: 19/483,107

(22) PCT Filed: May 18, 2023
(86) PCT No.: PCT/JP2023/018659

§ 371 Date: Nov. 10, 2025

(51) Int. Cl. G06N 3/04

(52) U.S. Cl. CPC G06N 3/04

(57) ABSTRACT

An information processing apparatus includes: an information acceptance unit that accepts self information; a feature acquisition unit that acquires self feature information from the self information; a transfer unit that determines node identifiers paired with a starting point condition satisfied by the self feature information, and determines a node identifier of a node that is connected via an edge to nodes that have fired and are identified by the node identifiers, to which the self feature information are to be transferred, and that fires based on a firing condition corresponding to the node; a pattern acquisition unit that acquires a self firing pattern including one or more node identifiers determined by the transfer unit; a self accumulation unit that acquires self pattern information, using the self firing pattern, and accumulates the self pattern information; and an output processing unit that performs processing, using the self pattern information.

### TECHNICAL FIELD

The present invention relates to an information processing apparatus or the like capable of performing information processing by imitating self-establishment.

### BACKGROUND ART

Conventionally, there is an electroencephalogram signal processing apparatus that acquires and processes electroencephalogram signals representing a subject's brain waves (see, for example, Patent Document 1 and Patent Document 2).

### BACKGROUND ART

### Patent Document

Patent Document 1: JP 2016-47239A.

Patent Document 2: JP 2016-52430A.

### SUMMARY OF INVENTION

### Technical Problem

However, in the conventional technology, it has not been possible to simulate the process in which a person or the like establishes oneself. It should be noted that the term “person or the like” usually refers to a human, but may also include animals such as other mammals, for example, monkeys or gorillas.

### Solution to Problem

An information processing apparatus according to a first aspect of the present invention is an information processing apparatus including: an NN storage unit in which neural network information is stored, the neural network information containing two or more pieces of node information each containing a node identifier, and one or more pieces of edge information each containing an edge identifier and specifying a connection between nodes; a starting point storage unit in which one or more pieces of starting point information are stored in association with a starting point condition that is a condition regarding one or more pieces of feature information of information to be accepted and that is a condition for determining a node where firing occurs without passing through other nodes, the one or more pieces of starting point information containing one or more node identifiers each specifying a node where firing occurs without passing through other nodes; a firing condition storage unit in which a firing condition is stored, the firing condition being associated with one or more pieces of node information of the two or more pieces of node information and being related to one or more pieces of feature information; a self storage unit in which self pattern information regarding a firing pattern of self information is stored; an information acceptance unit that accepts self information, which is information regarding oneself; a feature acquisition unit that acquires one or more pieces of self feature information, which are feature information, from the self information; a transfer unit that determines, from the starting point storage unit, one or more node identifiers paired with a starting point condition satisfied by the one or more pieces of self feature information acquired by the feature acquisition unit, and determines a node identifier of a node that is connected via an edge to one or more nodes that have fired and are identified by the one or more node identifiers, to which the one or more pieces of self feature information are to be transferred, and that fires based on a firing condition corresponding to the node; a pattern acquisition unit that acquires a self firing pattern including one or more node identifiers determined by the transfer unit; a self accumulation unit that acquires self pattern information, using the self firing pattern acquired by the pattern acquisition unit, and accumulates the self pattern information in the self storage unit; and an output processing unit that performs processing, using the self pattern information in the self storage unit.

With this configuration, it is possible to simulate the process in which a person or the like establishes oneself.

An information processing apparatus according to a second aspect of the present invention is the information processing according to the first aspect of the invention, further including: an other person storage unit in which other-person pattern information regarding a firing pattern of information regarding another person is stored, wherein the information acceptance unit accepts other-person information, which is information regarding another person, the feature acquisition unit acquires one or more pieces of other person feature information, which are feature information, from the other person information, the transfer unit determines, from the starting point storage unit, one or more node identifiers paired with a starting point condition satisfied by the one or more pieces of other person feature information acquired by the feature acquisition unit, and determines a node identifier of a node that is connected via an edge to one or more nodes that have fired and are identified by the one or more node identifiers, to which the one or more pieces of other person feature information are to be transferred, and that fires based on a firing condition corresponding to the node, the pattern acquisition unit acquires an other person firing pattern including one or more node identifiers determined by the transfer unit, the information processing apparatus further comprises an other person accumulation unit that acquires other person pattern information, using the other person firing pattern acquired by the pattern acquisition unit, and accumulates the other person pattern information in the other person storage unit, and the output processing unit performs processing, using the other person pattern information stored in the other person storage unit.

With this configuration, it is possible to simulate the process in which a person or the like recognizes others.

An information processing apparatus according to a third aspect of the present invention is the information processing apparatus according to the second aspect of the invention, further including: a self-establishment unit that acquires self-establishment information regarding a difference between the self pattern information and the other person pattern information, wherein the output processing unit performs processing, using the self-establishment information.

With this configuration, it is possible to simulate the process in which a person or the like establishes oneself with higher accuracy.

An information processing apparatus according to a fourth aspect of the present invention is the information processing apparatus according to any one of the first to third aspects of the invention, wherein the self pattern information contains occurrence rate information regarding an occurrence rate of firing in association with a node identifier of each of one or more nodes that have fired.

With this configuration, it is possible to simulate the process in which a person or the like establishes oneself with higher accuracy.

An information processing apparatus according to a fifth aspect of the present invention is the information processing apparatus according to any one of the first to fourth aspects of the invention, wherein the self information includes self voice information, which is a voice of oneself, and self image information, which is an image of oneself, and self voice pattern information, which is self pattern information corresponding to the self voice information, and self image pattern information, which is self pattern information corresponding to the self image information, are stored in the self storage unit.

With this configuration, it is possible to simulate the process in which a person or the like establishes oneself.

An information processing apparatus according to a sixth aspect of the present invention is the information processing apparatus according to any one of the first to fifth aspects of the invention, wherein the self pattern information in the self storage unit is associated with a self identifier.

With this configuration, it is possible to simulate the process in which a person or the like establishes oneself.

An information processing apparatus according to a seventh aspect of the present invention is the information processing apparatus according to the second aspect of the invention, wherein the other person pattern information in the other person storage unit is associated with an other person identifier.

With this configuration, it is possible to simulate the process in which a person or the like recognizes others.

### Advantageous Effects of Invention

With the information processing apparatus according to the present invention, it is possible to simulate the process in which a person or the like establishes oneself.

### BRIEF DESCRIPTION OF DRAWINGS

FIG. 1 is a block diagram of an information processing apparatus 1 according to a first embodiment.

FIG. 2 is a flowchart illustrating examples of operations of the information processing apparatus 1 according to the same.

FIG. 3 is a flowchart illustrating an example of firing transfer processing according to the same.

FIG. 4 is a flowchart illustrating an example of starting node processing according to the same.

FIG. 5 is a flowchart illustrating an example of firing time processing according to the same.

FIG. 6 is a flowchart illustrating an example of subsequent transfer processing according to the same.

FIG. 7 is a flowchart illustrating an example of firing judgment processing according to the same.

FIG. 8 is a flowchart illustrating an example of firing pattern processing according to the same.

FIG. 9 is an overview diagram of a computer system according to the same.

FIG. 10 is a block diagram of the computer system according to the same.

### DESCRIPTION OF EMBODIMENTS

Hereinafter, embodiments of an information processing apparatus and so on will be described with reference to the drawings. It should be noted that in the embodiments, constituent elements with the same reference signs perform similar operations, and therefore, repeated descriptions thereof may be omitted.

### First Embodiment

In the present embodiment, an information processing apparatus for simulating the process in which a person or the like establishes oneself will be described. More specifically, the present embodiment describes an information processing apparatus that acquires, accumulates, and uses self pattern information acquired when self information, such as one's own voice or one's own image, is received.

The present embodiment also describes an information processing apparatus that acquires, accumulates, and uses other person pattern information acquired when other person information, such as another person's voice or another person's image, is received.

Furthermore, the present embodiment describes an information processing apparatus that acquires and uses self-establishment information relating to differences between self pattern information and other person pattern information.

In this specification, the state in which information X is associated with information Y means that the information Y can be acquired from the information X or the information X can be acquired from the information Y, and there is no limitation on the method for associating the information. The information X and the information Y may be linked to each other or in the same buffer, the information X may be contained in the information Y, or the information Y may be contained in the information X, for example.

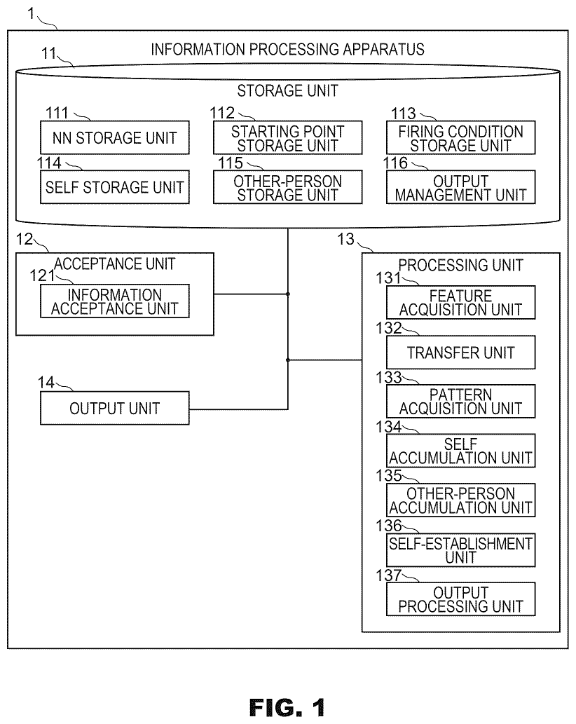

FIG. 1 is a block diagram of an information processing apparatus 1 according to the present embodiment. The information processing apparatus 1 includes a storage unit 11, an acceptance unit 12, a processing unit 13, and an output unit 14.

The storage unit 11 includes an NN storage unit 111, a starting point storage unit 112, a firing condition storage unit 113, a self storage unit 114, an other-person storage unit 115, and an output management unit 116. The acceptance unit 12 includes an information acceptance unit 121. The processing unit 13 includes a feature acquisition unit 131, a transfer unit 132, a pattern acquisition unit 133, a self accumulation unit 134, an other person accumulation unit 135, a self-establishment unit 136, and an output processing unit 137.

The storage unit 11 stores various kinds of information. Examples of the various kinds of information include neural network information (hereinafter, as appropriate, “NN information”), which will be described later, starting point information, which will be described later, firing conditions, which will be described later, self pattern information, which will be described later, other person pattern information, which will be described later, output management information, which will be described later, and firing information.

Firing information is information regarding the result of firing. Firing information contains a node identifier that identifies the node that has fired. Firing information may typically contain timer information indicating the time of firing. Timer information may be information indicating a relative time or may be time point information indicating an absolute time. Timer information may be considered a node attribute value. Firing information may contain the node identifier of the source node from which firing is transferred. Firing information may contain the edge identifier of the edge through which firing is transferred. It should be noted that firing information may be automatically deleted by the processing unit 13 after a certain period of time has elapsed since its accumulation.

The NN storage unit 111 stores NN information.

NN information is information emulating a neural network in the brain (hereinafter, as appropriate, “NN”). NN information is information that specifies an NN having two or more nodes and one or more edges connecting the nodes. NN information contains two or more pieces of node information and one or more pieces of edge information.

Node information is information regarding nodes that are included in the NN. Node information contains a node identifier. Node information contains, for example, one or more node attribute values.

A node identifier is, for example, information that identifies a node that is included in the NN. A node identifier is, for example, a node ID or a node name. Each node may be referred to as a soma. Node identifiers may be referred to as soma identifiers.

Examples of node attribute values include node position information, firing conditions, firing probability information, and count information.

Node position information is position information regarding a node. The position information is, for example, three-dimensional coordinate values (x, y, z), two-dimensional coordinate values (x, y), or a four-dimensional quaternion (x, y, x, w).

Firing conditions are conditions under which a node fires. Firing conditions may be considered the firing conditions stored in the firing condition storage unit 113. Details of firing conditions will be described later.

Firing probability information is information regarding the probability of firing. Firing probability information may be the firing probability itself or a value or the like obtained by converting the firing probability through a function or the like. It is preferable that firing probability information is referenced and a node may fire or not fire even if the feature information is the same, depending on the probability specified by the firing probability information.

Count information is information based on the number of times firing has occurred. Count information is, for example, the number of firings or the firing rate. The number of firings is, for example, the number of firings in a specific period or the cumulative number of firings. The firing rate is, for example, the proportion of firings in a specific period or the proportion of firings over the entire period. The firing rate of one node is “the number of times fired divided by the number of times a signal was transferred to that node”.

Edge information is information regarding edges included in the NN. Each piece of edge information is information that specifies an edge connecting nodes. Edge information typically contains an edge identifier. An edge identifier is information that identifies an edge. An edge identifier is, for example, an edge ID or an edge name. Edge information contains, for example, the node identifiers of two nodes connected by the edge. Edge information contains, for example, the node identifier of one node to be connected. When edge information contains only one node identifier, the edge is an edge in the growth process before connecting two nodes. Edge information contains one or more edge attribute values. Examples of edge attribute values include weight and edge position information. Weight can be considered information based on the thickness of an edge. The larger the weight, the easier it is for information to be transferred via the edge. Edge position information is position information regarding an edge. Edge position information is information that specifies the position of the endpoint of the edge. When edge information contains two node identifiers, for example, the edge information does not contain edge position information. When edge information contains two node identifiers, the edge specified by the edge information connects two nodes.

Edge information contains, for example, dendrite information and axon information. In this case, an edge contains a dendrite and an axon. An edge may be considered a single line or two or more branched lines. An edge may be referred to as a synapse.

Dendrite information is information regarding a dendrite. Dendrites are also referred to as dendritic processes, and are a part of neurons. Dendrites are multiple protrusions branching from the cell body like tree branches to receive external stimuli or information sent from the axons of other neurons. Here, a dendrite is an element included in an edge. Dendrite information contains a dendrite identifier and dendrite position information.

A dendrite identifier is information that identifies a dendrite. A dendrite identifier is, for example, a dendrite ID or a dendrite name.

Dendrite position information is position information regarding a dendrite. Dendrite position information is information that specifies the position of a dendrite and is, for example, one or more sets of three-dimensional coordinate values (x, y, z), or one or more sets of two-dimensional coordinate values (x, y). When dendrite position information contains two or more sets of coordinate values, the dendrite is a line connecting the points indicated by the two or more sets of coordinate values.

It is preferable that dendrite information contains retained energy amount information that indicates the amount of energy retained by the dendrite. It is preferable that dendrite information contains required energy amount information that indicates the amount of energy required to perform information transfer using the dendrite.

Axon information is information regarding an axon. An AXON is also known as an axonal process, is a protruding structure extending from the cell body, and is responsible for signal output in a nerve cell. Here, an axon is an element included in an edge. Axon information contains an axon identifier and axon position information.

An axon identifier is information that identifies an axon. An axon identifier is, for example, an axon ID or an axon name.

Axon position information is position information indicating the position of an axon. Axon position information is information that specifies the position of an axon and is, for example, one or more sets of three-dimensional coordinate values (x, y, z) or one or more sets of two-dimensional coordinate values (x, y). When axon position information contains two or more sets of coordinate values, an axon is a line connecting the points indicated by the two or more sets of coordinate values.

It is preferable that axon information contains retained energy amount information that indicates the amount of energy retained by the axon. Furthermore, it is preferable that axon information contains required energy amount information that indicates the amount of energy required to perform information transfer using the axon.

Dendrites and axons may branch. When a dendrites or an axon branches, the position information of each branch can be expressed by three or more sets of coordinate values. It should be noted that there is no limitation on the method for expressing dendrite position information and axon position information.

The starting point storage unit 112 stores one or more pieces of starting point information. Starting point information is information used to determine the node that first fires when information is accepted. Starting point information is associated with a starting point condition. Starting point information typically contains a node identifier that identifies a node that may fire first. Starting point information contains, for example, one or more node identifiers and a starting point condition. Starting point conditions are conditions for determining a node where firing occurs without passing through other nodes. Starting point conditions are conditions related to one or more pieces of feature information acquired from the information accepted by the information acceptance unit 121.

The firing condition storage unit 113 stores one or more firing conditions. Each firing condition is associated with node information. Each firing condition may be contained in node information. Firing conditions are conditions under which a node fires. It should be noted that the firing conditions are conditions related to one or more pieces of feature information.

The firing condition storage unit 113 stores firing conditions associated with one or more pieces of node information of two or more pieces of node information. It should be noted that node information not associated with any firing condition may or may not be present. Node information not associated with any firing condition is information regarding a node that always fires when a signal is transferred to it.

Firing conditions are, for example, conditions related to one or more pieces of feature information of sound information. Firing conditions in such a case are referred to as sound feature conditions. Sound feature conditions are, for example, conditions related to a specific frequency of sound information. Firing conditions in such a case are referred to as a frequency conditions. The frequency conditions are, for example, information specifying a frequency range (for example, “first threshold value<=frequency<=second threshold value”), information specifying an upper limit of the frequency (for example, “frequency <=second threshold value”), and information specifying a lower limit of the frequency (for example, “first threshold value<=frequency”). The frequency conditions are, for example, “<information identifier>frequency=Fa <condition>information amount≥100,” “<information identifier>Fa≤frequency<Fb<condition>information amount>100,” and “<information identifier>R<condition>information amount>150 & <information identifier>frequency=Fa<condition>information amount>180”. It should be noted that the frequencies Fa and Fb are values that indicate specific frequencies. The expression “<information identifier>frequency=Fa<condition>information amount>=100” means that the information amount (for example, volume) of the frequency “Fa” is 100 or more.

Firing conditions are, for example, conditions related to one or more pieces of feature information of image information. Firing conditions in such a case are referred to as image feature conditions. An image feature condition is, for example, “<information identifier>R<condition>information amount>=150”. The initial firing condition is, for example, “information amount of “R”>=150”, “(information amount of “R”>=150) & (information amount of “G”>=80)”, or “(information amount of “R”>=150) & (information amount of “G”>=80) & (information amount of “B”>=120)”.

Firing conditions are, for example, conditions regarding the occurrence rate at which a signal is transferred to a node. Such firing condition are referred to as occurrence rate conditions. The occurrence rate conditions are conditions regarding occurrence rate information. Occurrence rate information is information regarding the occurrence rate at which information is transferred to a node. Occurrence rate information is, for example, the time resolution at which a signal is transferred or the number of times a signal is transferred within a predetermined time. It should be noted that the information here is typically one or more pieces of feature information regarding the accepted information. The information here may also be referred to as a signal. The occurrence rate condition is, for example, a condition regarding a specific time resolution, a condition regarding a range of time resolutions, a condition regarding specific rhythm information, a condition regarding a range of similarity with respect to specific reference rhythm information, or the like. The time resolution is the number of time firing occurs per unit time. Rhythm information is a vector having, as elements, the values of two or more intervals (times) at which a signal was transferred. It should be noted that the transfer of a signal to a node refers to, for example, the firing of another node that is connected to the node via an edge. The node to which a signal is transferred is, for example, a node connected to an edge that has been judged to transfer the signal.

The firing condition may be, for example, a combination of two or more conditions selected from a sound feature condition, an image feature condition, and an occurrence rate condition.

The self storage unit 114 stores one or more pieces of self pattern information. Each piece of self pattern information is a firing pattern obtained in response to the acceptance of self information. It is preferable that a type identifier is associated with self pattern information. A type identifier is information indicating the type of information. A type identifier is, for example, “voice” or “image”. A type identifier may be “smell” or “tactile sensation”.

Self information is information regarding oneself. Self information is typically one or two types of information of self voice information and self image information. Self voice information is information regarding voice uttered by oneself. Voice information is an example of sound information. Self image information is information regarding an image acquired from oneself. An image acquired from oneself is typically an image captured of oneself, but may also be an illustration image of oneself or the like. Self information may be information regarding the smell of oneself or information regarding the tactile sensation of oneself.

A firing pattern is a pattern of nodes that have fired. A firing pattern is information specifying one or more nodes that have fired. A firing pattern is, for example, information containing the node identifiers of one or more nodes that have fired. A firing pattern is, for example, a vector in which elements corresponding to the node identifiers of nodes that have fired are set to “1”, and elements corresponding to the node identifiers of nodes that have not fired are set to “0”. A firing pattern is, for example, information containing occurrence rate information associated with the node identifiers of one or more nodes that have fired. The occurrence rate information is, for example, the number of times firing has occurred. Occurrence rate information is, for example, the number of times firing has occurred during a predetermined period.

Self pattern information is, for example, self voice pattern information of self image pattern information. Self voice pattern information is self pattern information corresponding to self voice information. Self voice pattern information is a firing pattern acquired when self voice information is accepted.

The other person storage unit 115 stores one or more pieces of other-person pattern information. Other person pattern information is a firing pattern acquired in response to the acceptance of other-person information. It is preferable that a type identifier is associated with other person pattern information.

Other person information is information regarding another person. Other person information is typically one or two types of information of other-person voice information and other person image information. Other person voice information is information regarding the voice uttered by another person. Other-person image information is typically an image captured of another person, but may also be an illustration image of another person or the like. Other person information may be information regarding the smell of another person or information regarding the tactile sensation of another person.

The output management unit 116 stores one or more pieces of output management information. Output management information is information that manages output information. Output management information contains an output condition and output information. An output condition is a condition for outputting information. An output condition is a condition using a firing pattern. An output condition is, for example, a condition using self-establishment information, which will be described later. An output condition is, for example, a similarity condition, which will be described later.

Output information is information to be output. There is no limitation on the content or data type of output information. “Output” here is a concept that encompasses displaying on a display screen, projection using a projector, printing by a printer, the output of a sound, transmission to an external device, accumulation on a recording medium, delivery of a processing result to another processing device or another program, and the like.

The acceptance unit 12 accepts various kinds of information. Examples of the various types of information include voice information or image information.

The acceptance unit 12 may accept, for example, smell information or tactile sensation information. Smell information is information that specifies a smell. Tactile sensation information is information that specifies the hardness (e.g., reaction force) when touched.

Here, “acceptance” is a concept that encompasses, for example, acceptance of information input from an input device such as a microphone, a camera, a keyboard, a mouse, or a touch panel, reception of information transmitted via a wired or wireless communication network, or acceptance of information read out from a recording medium such as an optical disk, a magnetic disk, or a semiconductor memory.

Any input means, such as a microphone, a camera, a phantom, a touch panel, a keyboard, a mouse, or a menu screen, may be used to input the various kinds of information.

The information acceptance unit 121 accepts information. Information is, for example, voice information or image information. The information acceptance unit 121 accepts, for example, self information. The information acceptance unit 121 accepts, for example, other person information. The self information accepted by the information acceptance unit 121 is typically associated with a self identifier. The other person information accepted by the information acceptance unit 121 is typically associated with an other person identifier.

A self identifier is information that identifies oneself. A self identifier is, for example, one's name, a firing pattern based on voice information when one's name is uttered, or a firing pattern based on image information when one's image (e.g., face image) is accepted. It should be noted that the name may be a nickname, a full name, or any name that identifies an individual.

An other-person identifier is information that identifies another person. An other-person identifier is, for example, another person's name, a firing pattern based on voice information when another person's name is uttered, or a firing pattern based on image information when another person's image is accepted.

The information acceptance unit 121 acquires, for example, sound information acquired by a microphone. The information acceptance unit 121 acquires, for example, image information captured by a camera.

The processing unit 13 performs various kinds of processing. The various kinds of processing is, for example, processing performed by the feature acquisition unit 131, the transfer unit 132, the pattern acquisition unit 133, the self accumulation unit 134, the other person accumulation unit 135, the self-establishment unit 136, or the output processing unit 137.

The processing unit 13 deletes one or more pieces of firing information that match deletion conditions from the pieces of firing information accumulated in the storage unit 11. Deletion conditions are, for example, conditions based on timer information contained in the firing information. A deletion condition is, for example, that a certain period has elapsed since the time specified by the timer information. Deletion conditions may be, for example, conditions based on count information and timer information. A deletion conditions is, for example, that the number of firings indicated by the count information is less than or equal to a threshold value or less than a threshold value, and a certain period has elapsed since the time specified by the timer information. In other words, it is preferable that the firing state of a node with a high number of firings persists longer.

The feature acquisition unit 131 acquires one or more pieces of feature information from the pieces of information accepted by the information acceptance unit 121. Feature information may also be referred to as a feature value.

When the accepted information is sound information, the acquired feature information is referred to as sound feature information. It is preferable that the one or more pieces of sound feature information include frequency. The one or more pieces of sound feature information may also include volume. The one or more pieces of sound feature information are, for example, MFCC or mel spectrum, but there is no limitation. When the accepted information is image information, the acquired feature information is referred to as image feature information. The one or more pieces of image feature information are typically R, G, and B values. One or more pieces of image feature information may include luminance, brightness, and saturation.

The feature acquisition unit 131 acquires one or more pieces of self feature information from the pieces of self information accepted by the information acceptance unit 121. The feature acquisition unit 131 acquires one or more pieces of self sound feature information from the pieces of self voice information accepted by the information acceptance unit 121. The feature acquisition unit 131 acquires one or more pieces of self image feature information from the self image information accepted by the information acceptance unit 121.

The feature acquisition unit 131 acquires one or more pieces of other-person feature information from the pieces of other person information accepted by the information acceptance unit 121. The feature acquisition unit 131 acquires one or more pieces of other person voice feature information from the pieces of other person voice information accepted by the information acceptance unit 121. The feature acquisition unit 131 acquires one or more pieces of other-person image feature information from the pieces of other person image information accepted by the information acceptance unit 121.

The transfer unit 132 determines one or more node identifiers corresponding to a starting point condition satisfied by the one or more pieces of feature information acquired by the feature acquisition unit 131. This determination is made to determine the node that fires first when information is accepted. Determining a node identifier is, for example, acquiring a node identifier. Determining a node identifier means that the node identified by that node identifier fires. It should be noted that when a node fires, for example, conceptually, one or more pieces of feature information are passed to another node connected to the node by an edge. Such one or more pieces of feature information are information at least temporarily held by the node.

The transfer unit 132 determines, from the starting point storage unit 112, one or more node identifiers paired with a starting point condition satisfied by the one or more pieces of self feature information acquired by the feature acquisition unit 131, for example.

The transfer unit 132 determines, from the starting point storage unit 112, one or more node identifiers paired with a starting point condition satisfied by the one or more pieces of other person feature information acquired by the feature acquisition unit 131, for example.

The transfer unit 132 determines the node identifiers of nodes that are connected by edges to a node that has fired, receive one or more pieces of feature information from the node that has fired, and fire based on the firing conditions corresponding to the nodes. This processing is firing transfer processing.

It is preferable that the transfer unit 132 recursively determines a node that is to fire and acquires the node identifier of the node.

The pattern acquisition unit 133 acquires a firing pattern. A firing pattern includes, for example, one or more node identifiers determined by the transfer unit 132.

The pattern acquisition unit 133 acquires, for example, a firing pattern that can be acquired from the firing information in the storage unit 11. The pattern acquisition unit 133 acquires, for example, a firing pattern including node identifiers included in the one or more pieces of firing information in the storage unit 11. Such firing information is firing information that has been accumulated in the storage unit 11 and that has not been deleted.

The pattern acquisition unit 133 acquires, for example, a firing pattern specifying nodes in the output layer among the one or more nodes determined by the transfer unit 132. In this case, the nodes identified by the one or more node identifiers contained in the firing pattern are nodes in the output layer.

The pattern acquisition unit 133 acquires, for example, a self firing pattern including one or more node identifiers determined by the transfer unit 132. A self firing pattern is information specifying one or more nodes that have fired in response to the acceptance of self information.

The pattern acquisition unit 133 acquires, for example, an other person firing pattern including one or more node identifiers determined by the transfer unit 132. An other person firing pattern is information specifying one or more nodes that have fired in response to the acceptance of other person information.

The self accumulation unit 134 acquires self pattern information using the self firing pattern acquired by the pattern acquisition unit 133 and accumulates the self pattern information in the self storage unit 114. It is preferable that the self accumulation unit 134 accumulates self pattern information in the self storage unit 114 in association with the self identifier.

Self pattern information may be a self firing pattern. Self pattern information may be occurrence rate information associated with one or more node identifiers. Self pattern information is, for example, a vector having, as elements, occurrence rate information associated with one or more node identifiers.

The other person accumulation unit 135 acquires other person pattern information using the other person firing pattern acquired by the pattern acquisition unit 133 and accumulates the other person pattern information in the other person storage unit 115. It is preferable that the other person accumulation unit 135 accumulates other person pattern information in the other person storage unit 115 in association with an other person identifier.

Other person pattern information may be an other person firing pattern. Other person pattern information may be occurrence rate information associated with one or more node identifiers. Other person pattern information is, for example, a vector having, as elements, occurrence rate information associated with one or more node identifiers. It is preferable that the data structure of self pattern information and the data structure of other person pattern information are the same.

The self-establishment unit 136 acquires self-establishment information using self pattern information and one or two or more pieces of other-person pattern information. The self-establishment unit 136 acquires self-establishment information regarding the difference between self pattern information and other person pattern information.

Self-establishment information is information regarding the establishment of oneself. Self-establishment information is information expressing the characteristics of oneself relative to others. Self-establishment information is information regarding the difference between self pattern information and other person pattern information. Self-establishment information is, for example, self voice establishment information based on self voice information or self image establishment information based on self image information. Self-establishment information is, for example, occurrence rate information associated with one or more node identifiers.

The self-establishment unit 136 acquires, for example, self-establishment information, which is a vector representing the difference between self pattern information, which is a vector, and other person pattern information, which is also a vector. The self-establishment unit 136 acquires, for example, self-establishment information as a vector representing the difference between self pattern information, which is a vector, and a representative vector of two or more pieces of other person pattern information, which are vectors. The self-establishment unit 136 acquires, for example, self-establishment information, which is a vector representing the difference between self pattern information, which is a vector having, as elements, occurrence rate information paired with two or more node identifiers, and other-person pattern information, which is a vector having, as elements, occurrence rate information paired with two or more node identifiers. The self-establishment unit 136, for example, uses self pattern information containing occurrence rate information paired with two or more node identifiers and other-person pattern information containing occurrence rate information paired with two or more node identifiers to compare the occurrence rate information for each node identifier, acquires one or more node identifiers for which the difference in occurrence rate information is greater than or equal to, a threshold value or greater than a threshold value, and forms self-establishment information containing the one or more node identifiers.

The self-establishment unit 136 acquires, for example, self-establishment information, which is a vector representing the difference between self pattern information containing occurrence rate information paired with two or more node identifiers and a representative vector of two or more pieces of other person pattern information containing occurrence rate information paired with two or more node identifiers. The representative vector of two or more pieces of other-person pattern information is a vector having, as elements, the representative values of the corresponding elements of two or more pieces of other person pattern information, which are vectors. Representative values are, for example, an average value or a median value. It should be noted that self-establishment information may be self pattern information.

The output processing unit 137, for example, determines an output condition satisfied by a firing pattern acquired by the pattern acquisition unit 133, acquires output information paired with the output condition from the output management unit 116, and outputs the output information.

Here, “output” is a concept that encompasses displaying on a display screen, projection using a projector, printing by a printer, the output of a sound, transmission to an external device, accumulation on a recording medium, delivery of a processing result to another processing device or another program, and the like.

The output processing unit 137 performs processing using, for example, the self pattern information in the self storage unit 114. The output processing unit 137 performs processing using, for example, the other-person pattern information in the other person storage unit 115. The output processing unit 137 performs processing using, for example, the self-establishment information in the self storage unit 114. It should be noted that there is no limitation on the content of the processing.

For example, when other person pattern information acquired based on the other person information accepted by the information acceptance unit 121 and the self pattern information in the self storage unit 114 satisfy a similarity condition, the output processing unit 137 acquires output information paired with the similarity condition from the output management unit 116 and outputs the output information. It should be noted that a similarity condition is a condition for judging that another person and oneself are similar. A similarity condition is, for example, that the difference between self pattern information and other person pattern information (for example, the magnitude of the vector representing the difference) is smaller than or equal to a threshold value or smaller than a threshold value. In this case, the output information is a voice indicating surprise or an image indicating surprise.

The output unit 14 outputs various kinds of information. Such information is, for example, the output information in the output management unit 116.

Here, “output” is a concept that encompasses displaying on a display screen, projection using a projector, printing by a printer, the output of a sound, transmission to an external device, accumulation on a recording medium, delivery of a processing result to another processing device or another program, and the like.

It is preferable that the storage unit 11, the NN storage unit 111, the starting point storage unit 112, the firing condition storage unit 113, the self storage unit 114, the other person storage unit 115, and the output management unit 116 are realized using a non-volatile recording media, but they can be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12 and the information acceptance unit 121 may be realized using a wireless or wired communication means, but may also be realized using, for example, means for receiving broadcast, a device driver for the input means such as a touch panel or a keyboard, or control software or the like for controlling the menu screen.

The information acceptance unit 121 is realized using, for example, a microphone, a camera, a phantom, or the like.

The processing unit 13, the feature acquisition unit 131, the transfer unit 132, the pattern acquisition unit 133, the self accumulation unit 134, the other person accumulation unit 135, the self-establishment unit 136, and the output processing unit 137 can typically be realized using a processor, a memory, and so on. The processing procedures performed by the processing unit 13 and so on are typically realized using software, and the software is recorded on a recording medium such as a ROM. However, such processing procedures may be realized using hardware (a dedicated circuit). It should be noted that the processor may be a CPU, an MPU, a GPU, or the like, and there is no limitation on the type thereof.

The output unit 14 may be regarded as including or not including an output device such as a display or a speaker. The output unit 14 can be realized using the driver software of the output device, the driver software of the output device and the output device, or the like.

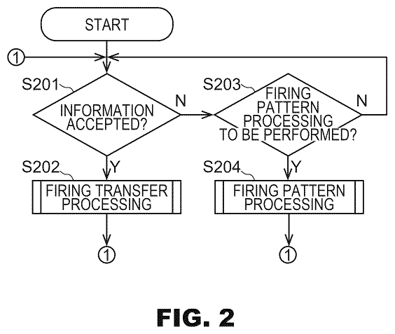

Next, examples of operations of the information processing apparatus 1 will be described with reference to the flowchart in FIG. 2.

(Step S201) The information acceptance unit 121 judges whether or not information has been accepted. If information has been accepted, processing proceeds to step S202, and if information has not been accepted, processing proceeds to step S203.

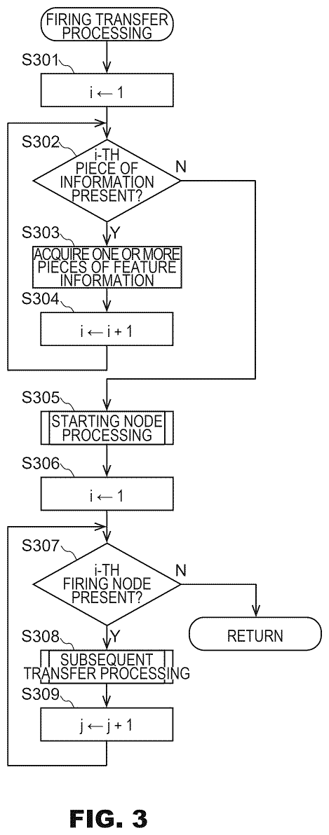

(Step S202) The transfer unit 132 and so on perform firing transfer processing. Processing returns to step S201. An example of firing transfer processing will be described with reference to the flowchart in FIG. 3. It should be noted that firing transfer processing is processing that simulates the transfer of signals within the NN in response to the acceptance of information.

(Step S203) The processing unit 13 judges whether or not it is time to perform firing pattern processing. If it is time to perform firing pattern processing, processing proceeds to step S204, and if it is not time to perform firing pattern processing, processing returns to step S201.

It should be noted that the time to perform firing pattern processing is, for example, when a node has fired, periodically, continuously, or when there exists a node that has fired within a predetermined time from the current point in time. There is no limitation on the time to perform firing pattern processing. The time when a node fires is typically when the firing information is accumulated in the storage unit 11.

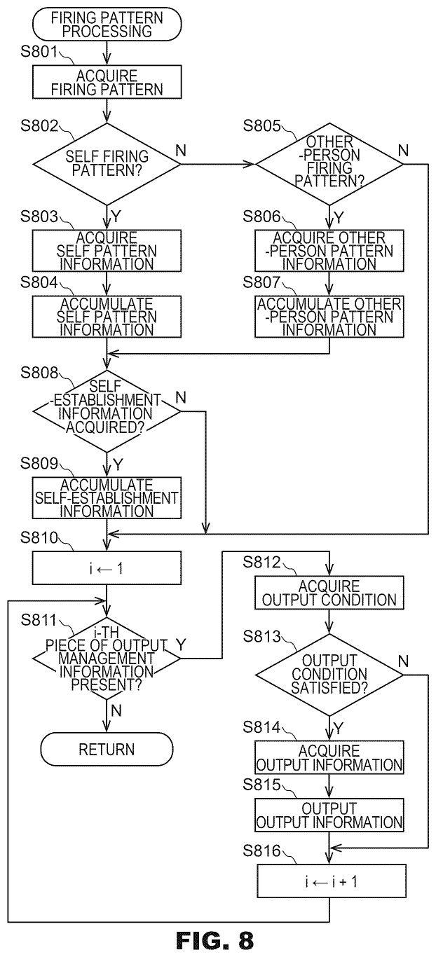

(Step S204) The output processing unit 137 and so on perform firing pattern processing. Processing returns to step S201. An example of firing pattern processing will be described with reference to the flowchart in FIG. 8.

It should be noted that firing pattern processing is processing performed to detect a firing pattern related to fired nodes and output information corresponding to that firing pattern.

It should be noted that, in the flowchart in FIG. 2, processing is terminated when power is turned off or an interruption is made to terminate the processing.

Next, an example of the firing transfer processing in step S202 will be described with reference to the flowchart in FIG. 3.

(Step S301) The transfer unit 132 assigns 1 to a counter i.

(Step S302) The transfer unit 132 judges whether or not an i-th piece of information is present in the pieces of information accepted in S201. If the i-th piece of information is present, processing proceeds to step S303, and otherwise processing proceeds to step S306.

It should be noted that the information accepted in S201 is, for example, one or two types of information of voice information and image information. The information is, for example, one or more types of information of self voice information, self image information, other person voice information, or other-person image information.

(Step S303) The feature acquisition unit 131 acquires one or more pieces of feature information from the i-th piece of information and temporarily accumulates them in a buffer (not shown). It should be noted that if the i-th piece of information is voice information, it is preferable that the one or more pieces of feature information include frequency. If the i-th piece of information is image information, it is preferable that the one or more pieces of feature information include the information amounts of “R”, “G”, and “B”.

(Step S304) The transfer unit 132 increments the counter i by one. Processing return to step S302.

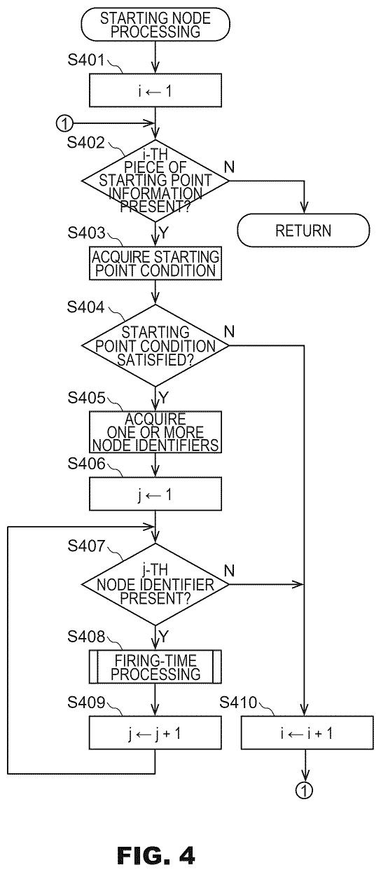

(Step S305) The transfer unit 132 performs starting node processing using one or more pieces of feature information stored in the buffer (not shown). An example of starting node processing will be described with reference to the flowchart in FIG. 4. It should be noted that starting node processing is processing performed to determine the node that fires first upon acceptance of information.

(Step S306) The transfer unit 132 assigns 1 to the counter i.

(Step S307) The transfer unit 132 judges whether or not the i-th firing node is present in the nodes that have been judged to fire in step S305. If the i-th firing node is present, processing proceeds to step S308, and otherwise processing returns to the higher-level processing.

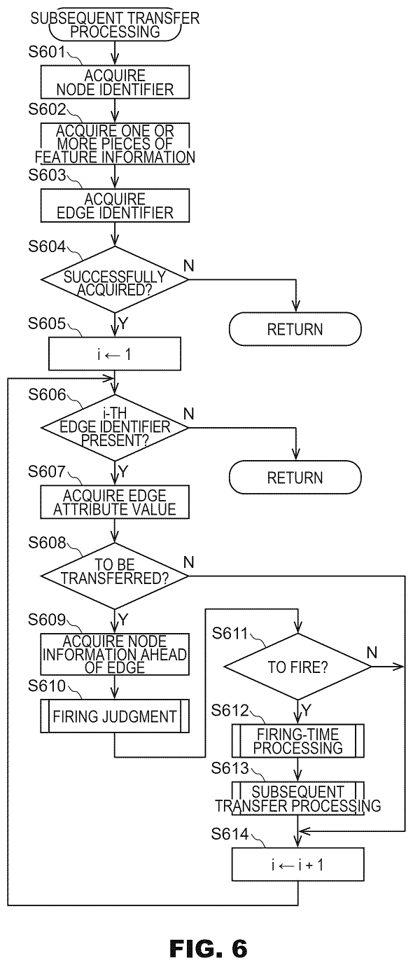

(Step S308) The transfer unit 132 performs subsequent transfer processing. An example of subsequent transfer processing will be described with reference to the flowchart in FIG. 6. It should be noted that subsequent transfer processing is processing that simulates the transfer of firing from one node to the next node connected to the one node by an edge. The subsequent transfer processing is processing performed to determine the node that receives one or more pieces of feature information from the firing node of interest, and that fires next.

(Step S309) The transfer unit 132 increments the counter i by one. The processing returns to step S307.

Next, an example of the starting node processing in step S305 will be described with reference to the flowchart in FIG. 4.

(Step S401) The transfer unit 132 assigns 1 to the counter i.

(Step S402) The transfer unit 132 judges whether or not the i-th piece of starting point information is present in the starting point storage unit 112. If the i-th piece of starting point information is present, processing proceeds to step S403, and otherwise processing returns to the higher-level processing.

(Step S403) The transfer unit 132 acquires the starting point condition contained in the i-th piece of starting point information from the starting point storage unit 112.

(Step S404) The transfer unit 132 judges whether or not the one or more pieces of feature information stored in the buffer (not shown) in step S303 satisfy the i-th starting point condition acquired in step S403. If the one or more pieces of feature information satisfy the i-th starting point condition, processing proceeds to step S405, and otherwise processing proceeds to step S410.

(Step S405) The transfer unit 132 acquires one or more node identifiers paired with the i-th starting point condition from the starting point storage unit 112

(Step S406) The transfer unit 132 assigns 1 to a counter j.

(Step S407) The transfer unit 132 judges whether or not the j-th node identifier is present in the one or more node identifiers acquired in step S405. If the j-th node identifier is present, processing proceeds to step S408, and otherwise processing proceeds to step S410.

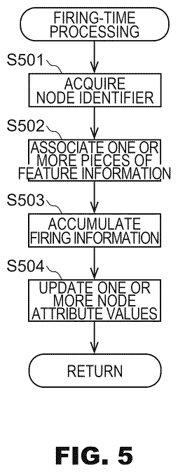

(Step S408) The transfer unit 132 performs firing-time processing for the node identified by the j-th node identifier. An example of firing-time processing will be described with reference to the flowchart in FIG. 5. It should be noted that firing-time processing is processing performed when a node fires.

(Step S409) The transfer unit 132 increments the counter j by one. Processing returns to step S407.

(Step S410) The transfer unit 132 increments the counter i by one. Processing returns to step S402.

It should be noted that in the flowchart in FIG. 4, if no starting point condition is present in the starting point storage unit 112, the transfer unit 132 acquires one or more node identifiers from the starting point storage unit 112 and processing proceeds to step S406. This is the case where the node that fires first is determined in advance.

Next, an example of the firing-time processing in steps S408 and S612 will be described with reference to the flowchart in FIG. 5.

(Step S501) The transfer unit 132 acquires the node identifier of the node that is to fire. It should be noted that this node identifier is, for example, the j-th node identifier in step S407.

(Step S502) The transfer unit 132 acquires one or more pieces of feature information and associates the one or more pieces of feature information with the node identifier acquired in step S501.

It should be noted that the one or more pieces of feature information are feature information acquired from the accepted information or feature information associated with the source node from which firing is transferred. Feature information associated with the source node from which firing is transferred is typically the same as the feature information acquired from the accepted information. Feature information associated with the source node from which firing is transferred may be feature information included in the feature information acquired from the accepted information, used only for the firing condition judgment.

(Step S503) The transfer unit 132 acquires timer information that specifies the time of firing. The transfer unit 132 forms firing information containing the node identifier acquired in step S501 and the timer information. The transfer unit 132 accumulates the firing information in the storage unit 11.

It should be noted that the transfer unit 132 acquires, for example, timer information specifying the time of firing from a clock (not shown). The transfer unit 132 may acquire, for example, the node identifier of the firing source node and the edge identifier of the edge via which firing has been transferred, form firing information containing the node identifier and the edge identifier, and accumulate it in the storage unit 11.

(Step S504) The transfer unit 132 updates one or more node attribute values paired with the node identifier acquired in step S501. Processing returns to the higher-level processing.

Here, the transfer unit 132 increases, for example, the count information paired with the node identifier acquired in step S501 by one. The transfer unit 132 increases, for example, the firing probability information paired with the node identifier acquired in step S501. It should be noted that there is no limitation on the amount of increase. The transfer unit 132, for example, assigns the original firing probability information to an increasing function that uses the firing probability information as a parameter, executes the increasing function, acquires new firing probability information, and rewrites the original firing probability information with the new firing probability information.

Next, an example of the subsequent transfer processing in step S308 will be described with reference to the flowchart in FIG. 6.

(Step S601) The transfer unit 132 acquires the node identifier of the node of interest. It should be noted that the node of interest is the i-th firing node in step S307.

(Step S602) The transfer unit 132 acquires one or more pieces of feature information paired with the node identifier acquired in step S601. The one or more pieces of feature information paired with the node identifier may be one or more pieces of feature information paired with a node that is connected by an edge to the node identified by the node identifier and that has previously fired.

(Step S603) The transfer unit 132 acquires one or more edge identifiers paired with the node identifier acquired in step S601 from the NN storage unit 111. It should be noted that the one or more edge identifiers are identifiers of edges ahead of the node. Ahead of the node means the destination to which a signal is transferred from the node. The transfer of a signal may be considered as passing one or more pieces of feature information.

(Step S604) The transfer unit 132 judges whether or not one or more edge identifiers have been successfully acquired in step S603. If edge identifiers have been successfully acquired, processing proceeds to step S605, and if edge identifiers have not been successfully acquired, processing returns to the higher-level processing. If no edge identifier paired with the node identifier has been successfully acquired, it means that the node identified by the node identifier is a node in the output layer of the NN's node group.

(Step S605) The transfer unit 132 assigns 1 to the counter i.

(Step S606) The transfer unit 132 judges whether or not the i-th edge identifier is present in the edge identifiers acquired in step S603. If the i-th edge identifier is present, processing proceeds to step S607, and otherwise processing returns to the higher-level processing.

(Step S607) The transfer unit 132 acquires one or more edge attribute values paired with the i-th edge identifier from the NN storage unit 111. It should be noted that the one or more edge attribute values include, for example, weight.

(Step S608) The transfer unit 132 judges whether or not to transfer a signal through the edge using the one or more edge attribute values (e.g., weight) acquired in step S607. If the signal is to be transferred, processing proceeds to step S609, and otherwise processing proceeds to step S614.

It should be noted that the transfer unit 132 typically increases the probability of judging to transfer the signal as the weight increases. The transfer unit 132 acquires, for example, the probability of judging to transfer the signal, using an increasing function that uses the weight as a parameter and judges whether or not to transfer the signal based on the probability. The transfer unit 132 generates, for example, a random number and judges whether or not to transfer the signal based on the probability using the random number.

(Step S609) The transfer unit 132 acquires node information of the node ahead of the edge. More specifically, the transfer unit 132 acquires the node identifier that is paired with the i-th edge identifier and that is the node identifier of the node to which the signal is to be transferred, and acquires the node information of the node identified by the node identifier from the NN storage unit 111.

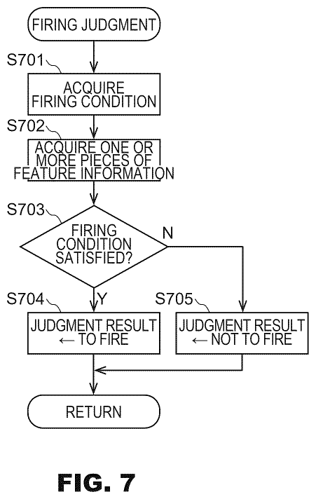

(Step S610) The transfer unit 132 performs firing judgment processing for the node, using the node information acquired in step S609. An example of the firing judgment processing will be described with reference to the flowchart in FIG. 7.

(Step S611) If the judgment result in step S610 is “to fire”, the transfer unit 132 proceeds to step S612, and if the determination result is “not to fire”, the transfer unit 132 proceeds to step S614.

(Step S612) The transfer unit 132 performs firing-time processing for the node specified by the node information acquired in step S609. Firing-time processing is the processing in the flowchart in FIG. 5.

(Step S613) The transfer unit 132 performs subsequent transfer processing for the node specified by the node information acquired in step S609. Subsequent transfer processing is the processing in the flowchart in FIG. 6.

(Step S614) The transfer unit 132 increments the counter i by one. Processing returns to step S606.

Next, an example of the firing judgment processing in step S610 will be described with reference to the flowchart in FIG. 7.

(Step S701) The transfer unit 132 acquires a firing condition corresponding to the node of interest from the firing condition storage unit 113. The transfer unit 132 acquires, for example, a firing condition paired with the node identifier contained in the node information of the node of interest from the firing condition storage unit 113.

(Step S702) The transfer unit 132 acquires one or more pieces of feature information corresponding to the node of interest.

(Step S703) The transfer unit 132 judges whether or not the one or more pieces of feature information acquired in step S702 satisfy the firing condition acquired in step S701. If the firing condition is satisfied, processing proceeds to step S704, and if the firing condition is not satisfied, processing proceeds to step S705.

(Step S704) The transfer unit 132 assigns “to fire” to the variable “judgment result”. Processing returns to the higher-level processing.

(Step S705) The transfer unit 132 assigns “not to fire” to the variable “judgment result”. Processing returns to the higher-level processing.

Next, an example of the firing pattern processing in step S204 will be described with reference to the flowchart in FIG. 8.

(Step S801) The pattern acquisition unit 133 acquires one or more node identifiers paired with timer information indicating that a node is currently firing from the firing information stored in the storage unit 11. It should be noted that, for example, if the difference between the current time and the timer information indicating the time of firing is less than or equal to a threshold value or less than a threshold value, the pattern acquisition unit 133 judges that the node identified by the node identifier paired with the timer information is currently firing. The acquired one or more node identifiers constitute a firing pattern. The firing pattern here is a set of node identifiers of nodes that are currently firing.

It should be noted that the pattern acquisition unit 133 may acquire one or more node identifiers of nodes in the output layer that have not been deleted from the firing information stored in the storage unit 11 and acquire a firing pattern including the one or more node identifiers.

(Step S802) The self accumulation unit 134 judges whether or not the firing pattern acquired in step S801 is a self firing pattern. If the firing pattern is a self firing pattern, processing proceeds to step S803, and otherwise processing proceeds to step S805.

For example, the self accumulation unit 134 judges that the firing pattern acquired in step S801 is a self firing pattern if a self identifier is associated with the information accepted by the information acceptance unit 121.

It should be noted that the case where a self identifier is associated with information accepted by the information acceptance unit 121 is, for example, a case where the information acceptance unit 121 accepts image information of a captured image of a mirror in which oneself is reflected. It is preferable that such image information is associated with a type identifier “image”. The case where a self identifier is associated with information accepted by the information acceptance unit 121 is, for example, a case where the time difference between the time at which the processing unit 13 acquires information indicating that oneself has uttered a voice and the time at which the information acceptance unit 121 accepts voice information is within a threshold value. It is preferable that such voice information is associated with a type identifier “voice”. For example, if a firing pattern, which is a pattern of nodes that fire when one's own name is uttered, has been accumulated in the storage unit 11 within a threshold time from the current time, the self accumulation unit 134 judges that a self identifier is associated with the information accepted by the information acceptance unit 121. Such a case is a case where oneself utters a voice immediately after one's own name is uttered by another person, and where the information acceptance unit 121 accepts voice information resulting from the utterance. It is preferable that such voice information is associated with a type identifier “voice”. It should be noted that there is no limitation on the method of associating a self identifier with the information accepted by the information acceptance unit 121.

(Step S803) The self accumulation unit 134 acquires self pattern information, using the firing pattern acquired in step S801.

The self accumulation unit 134 increases, for example, occurrence rate information paired with a node identifier that matches a node identifier contained in the firing pattern acquired in step S801 and that is contained in the self pattern information in the self storage unit 114. The amount of increase is, for example, “1”.

The self accumulation unit 134 acquires, for example, self pattern information, which is the firing pattern acquired in step S801.

(Step S804) The self accumulation unit 134 accumulates the self pattern information acquired in step S803 in the self storage unit 114 in association with the self identifier. Processing proceeds to step S808.

It is preferable that the self accumulation unit 134 acquires the type identifier (e.g., “voice” or “image”) of the information accepted by the information acceptance unit 121 and accumulates the self pattern information in the self storage unit 114 in association with the type identifier.

(Step S805) The other-person accumulation unit 135 judges whether or not the firing pattern acquired in step S801 is an other person firing pattern. If the firing pattern is an other person firing pattern, processing proceeds to step S806, and otherwise processing proceeds to step S810.

For example, if the information accepted by the information acceptance unit 121 is associated with an other-person identifier, the other person accumulation unit 135 judges that the firing pattern acquired in step S801 is an other-person firing pattern.

It should be noted that the case where the information accepted by the information acceptance unit 121 is associated with an other person identifier is, for example, a case where the information acceptance unit 121 accepts image information capturing another person. It is preferable that such image information is associated with a type identifier “image”. The case where the information accepted by the information acceptance unit 121 is associated with other person identifier is, for example, a case where the time difference between the time at which the processing unit 13 acquires information indicating that another person has uttered a voice and the time at which the information acceptance unit 121 accepts voice information is within a threshold value. It is preferable that such voice information is associated with a type identifier “voice”. For example, if a firing pattern, which is a pattern of nodes that fire when another person's name is uttered, has been accumulated in the storage unit 11 within a threshold time from the current time, the other person accumulation unit 135 judges that the information accepted by the information acceptance unit 121 is associated with an other person identifier. Such a case is a case where another person utters a voice immediately after oneself utters the other person's name, and the information acceptance unit 121 accepts voice information resulting from the utterance. It is preferable that such voice information is associated with a type identifier “voice”. It should be noted that there is no limitation on the method of associating an other person identifier with the information accepted by the information acceptance unit 121.

(Step S806) The other person accumulation unit 135 acquires other-person pattern information, using the firing pattern acquired in step S801.

(Step S807) The other-person accumulation unit 135 accumulates the other person pattern information acquired in step S806 in the other-person storage unit 115.

(Step S808) The self-establishment unit 136 judges whether or not to acquire self-establishment information. If self-establishment information is to be acquired, processing proceeds to step S809, and if self-establishment information is not to be acquired, processing proceeds to step S810.

It should be noted that the self-establishment unit 136 may always judge that self-establishment information is to be acquired. The self-establishment unit 136 may judge that self-establishment information is to be acquired, for example, only when self pattern information is accumulated or only when other person pattern information is accumulated. For example, the self-establishment unit 136 may judge that self-establishment information is to be acquired only when accumulated self pattern information satisfies a predetermined condition. For example, the self-establishment unit 136 may judge that self-establishment information is to be acquired only when accumulated other person pattern information satisfies a predetermined condition.

(Step S809) The self-establishment unit 136 acquires self-establishment information, using the self pattern information in the self storage unit 114 and one or more pieces of other person pattern information in the other person storage unit 115. The self-establishment unit 136 accumulates the self-establishment information in the self storage unit 114.

(Step S810) The output processing unit 137 assigns 1 to the counter i.

(Step S811) The output processing unit 137 judges whether or not the i-th piece of output management information is present in the output management unit 116. If the i-th piece of output management information is present, processing proceeds to step S812, and otherwise processing returns to the higher-level processing.

(Step S812) The output processing unit 137 acquires the output condition contained in the i-th piece of output management information from the output management unit 116.

(Step S813) The output processing unit 137 judges whether or not the firing pattern acquired in step S801 or the self-establishment information acquired in step S809 satisfies the output condition. If the output condition is satisfied, processing proceeds to step S813, and if the output condition is not satisfied, processing proceeds to step S816.

For example, the output processing unit 137 judges that the output condition is satisfied if all of the node identifiers contained in the output condition are included in the firing pattern acquired in step S801.

(Step S814) The output processing unit 137 acquires the output information contained in the i-th piece of output management information from the output management unit 116.

(Step S815) The output processing unit 137 or the output unit 14 outputs the output information acquired in step S806.

(Step S816) The output processing unit 137 increments the counter i by one. Processing returns to step S811.

As described above, according to this embodiment, it is possible to simulate the process in which a person or the like recognizes oneself. Additionally, according to this embodiment, it is possible to simulate the process in which a person or the like establishes oneself with higher accuracy. Furthermore, according to this embodiment, it is possible to simulate the process in which a person or the like recognizes others.

It should be noted that the processing in this embodiment may be realized using software. This software may be distributed through software downloading or the like. Also, this software may be recorded on a recording medium such as a CD-ROM and distributed. It should be noted that the same applies to the other embodiments in the present description. It should be noted that the software that realizes the information processing apparatus 1 according to this embodiment is the program described below. That is to say, this program is a program that enables a computer that can access: an NN storage unit in which neural network information is stored, the neural network information containing two or more pieces of node information each containing a node identifier, and one or more pieces of edge information each containing an edge identifier and specifying a connection between nodes; a starting point storage unit in which one or more pieces of starting point information are stored in association with a starting point condition that is a condition regarding one or more pieces of feature information of information to be accepted and that is a condition for determining a node where firing occurs without passing through other nodes, the one or more pieces of starting point information containing one or more node identifiers each specifying a node where firing occurs without passing through other nodes; a firing condition storage unit in which a firing condition is stored, the firing condition being associated with one or more pieces of node information of the two or more pieces of node information and being related to one or more pieces of feature information; and a self storage unit in which self pattern information regarding a firing pattern of self information is stored, to function as: an information acceptance unit that accepts self information, which is information regarding oneself, a feature acquisition unit that acquires one or more pieces of self feature information, which are feature information, from the self information; a transfer unit that determines, from the starting point storage unit, one or more node identifiers paired with a starting point condition satisfied by the one or more pieces of self feature information acquired by the feature acquisition unit, and determines a node identifier of a node that is connected via an edge to one or more nodes that have fired and are identified by the one or more node identifiers, to which the one or more pieces of self feature information are to be transferred, and that fires based on a firing condition corresponding to the node; a pattern acquisition unit that acquires a self firing pattern including one or more node identifiers determined by the transfer unit; a self accumulation unit that acquires self pattern information, using the self firing pattern acquired by the pattern acquisition unit, and accumulates the self pattern information in the self storage unit; and an output processing unit that performs processing, using the self pattern information in the self storage unit.

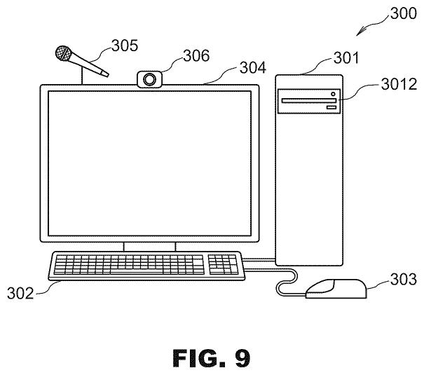

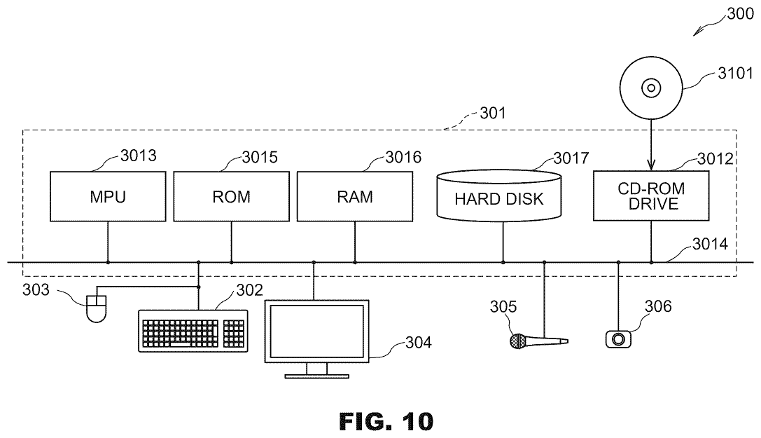

FIG. 9 shows an external appearance of a computer that executes the program described in the present description and realizes the information processing apparatus 1 and so on according to the various embodiments described above. The above-described embodiments can be realized using computer hardware and a computer program executed thereon. FIG. 9 is an overview diagram of this computer system 300, and FIG. 10 is a block diagram of the system 300.

In FIG. 9, the computer system 300 includes a computer 301 that includes a CD-ROM drive, a keyboard 302, a mouse 303, a monitor 304, a microphone 305, and a camera 306.

In FIG. 10, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the information processing apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the information processing apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

There may be a single or multiple computers executing the above-described program. In other words, centralized processing or distributed processing may be performed.

Also, as a matter of course, in each of the above-described embodiments, two or more communication means that are present in one apparatus may be physically realized using one medium.

Also, in the above-described embodiments, each kind of processing may be realized as centralized processing that is performed by a single apparatus, or distributed processing that is performed by multiple apparatuses.

As a matter of course, the present invention is not limited to the above-described embodiments, and various changes are possible, and such variations are also included within the scope of the present invention.

### Industrial Applicability

As described above, the information processing apparatus 1 according to the present invention has the effect of being able to simulate the process in which a person or the like establishes oneself and is useful as a simulator or the like for simulating the processing in the brain performed when establishing oneself.

1. An information processing apparatus comprising:
an NN storage unit in which neural network information is stored, the neural network information containing two or more pieces of node information each containing a node identifier, and one or more pieces of edge information each containing an edge identifier and specifying a connection between nodes;
a starting point storage unit in which one or more pieces of starting point information are stored in association with a starting point condition that is a condition regarding one or more pieces of feature information of information to be accepted and that is a condition for determining a node where firing occurs without passing through other nodes, the one or more pieces of starting point information containing one or more node identifiers each specifying a node where firing occurs without passing through other nodes;
a firing condition storage unit in which a firing condition is stored, the firing condition being associated with one or more pieces of node information of the two or more pieces of node information and being related to one or more pieces of feature information;
a self storage unit in which self pattern information regarding a firing pattern of self information is stored;
an information acceptance unit that accepts self information, which is information regarding oneself;
a feature acquisition unit that acquires one or more pieces of self feature information, which are feature information, from the self information;
a transfer unit that determines, from the starting point storage unit, one or more node identifiers paired with a starting point condition satisfied by the one or more pieces of self feature information acquired by the feature acquisition unit, and determines a node identifier of a node that is connected via an edge to one or more nodes that have fired and are identified by the one or more node identifiers, to which the one or more pieces of self feature information are to be transferred, and that fires based on a firing condition corresponding to the node;
a pattern acquisition unit that acquires a self firing pattern including one or more node identifiers determined by the transfer unit;
a self accumulation unit that acquires self pattern information, using the self firing pattern acquired by the pattern acquisition unit, and accumulates the self pattern information in the self storage unit; and
an output processing unit that performs processing, using the self pattern information in the self storage unit.

2. The information processing apparatus according to claim 1, further comprising:
an other-person storage unit in which other-person pattern information regarding a firing pattern of information regarding another person is stored,
wherein the information acceptance unit accepts other-person information, which is information regarding another person,
the feature acquisition unit acquires one or more pieces of other-person feature information, which are feature information, from the other-person information,
the transfer unit determines, from the starting point storage unit, one or more node identifiers paired with a starting point condition satisfied by the one or more pieces of other-person feature information acquired by the feature acquisition unit, and determines a node identifier of a node that is connected via an edge to one or more nodes that have fired and are identified by the one or more node identifiers, to which the one or more pieces of other-person feature information are to be transferred, and that fires based on a firing condition corresponding to the node,
the pattern acquisition unit acquires an other-person firing pattern including one or more node identifiers determined by the transfer unit,
the information processing apparatus further comprises an other-person accumulation unit that acquires other-person pattern information, using the other-person firing pattern acquired by the pattern acquisition unit, and accumulates the other-person pattern information in the other-person storage unit, and
the output processing unit performs processing, using the other-person pattern information stored in the other-person storage unit.

3. The information processing apparatus according to claim 2, further comprising:
a self-establishment unit that acquires self-establishment information regarding a difference between the self pattern information and the other-person pattern information,
wherein the output processing unit performs processing, using the self-establishment information.

4. The information processing apparatus according to claim 1,
wherein the self pattern information contains occurrence rate information regarding an occurrence rate of firing in association with a node identifier of each of one or more nodes that have fired.

5. The information processing apparatus according to claim 1,
wherein the self information includes self voice information, which is a voice of oneself, and self image information, which is an image of oneself, and
self voice pattern information, which is self pattern information corresponding to the self voice information, and self image pattern information, which is self pattern information corresponding to the self image information, are stored in the self storage unit.

6. The information processing apparatus according to claim 1,
wherein the self pattern information in the self storage unit is associated with a self identifier.

7. The information processing apparatus according to claim 2,
wherein the other-person pattern information in the other-person storage unit is associated with an other-person identifier.

8. An information processing method realized using: an NN storage unit in which neural network information is stored, the neural network information containing two or more pieces of node information each containing a node identifier, and one or more pieces of edge information each containing an edge identifier and specifying a connection between nodes; a starting point storage unit in which one or more pieces of starting point information are stored in association with a starting point condition that is a condition regarding one or more pieces of feature information of information to be accepted and that is a condition for determining a node where firing occurs without passing through other nodes, the one or more pieces of starting point information containing one or more node identifiers each specifying a node where firing occurs without passing through other nodes; a firing condition storage unit in which a firing condition is stored, the firing condition being associated with one or more pieces of node information of the two or more pieces of node information and being related to one or more pieces of feature information; a self storage unit in which self pattern information regarding a firing pattern of self information is stored; an information acceptance unit; a feature acquisition unit; a transfer unit; a pattern acquisition unit; a self accumulation unit; and an output processing unit, the information processing method comprising:
an information acceptance step of accepting self information, which is information regarding oneself;
a feature acquisition step in which the feature acquisition unit acquires one or more pieces of self feature information, which are feature information, from the self information;
a transfer step in which the transfer unit determines, from the starting point storage unit, one or more node identifiers paired with a starting point condition satisfied by the one or more pieces of self feature information acquired in the feature acquisition step, and determines a node identifier of a node that is connected via an edge to one or more nodes that have fired and are identified by the one or more node identifiers, to which the one or more pieces of self feature information are to be transferred, and that fires based on a firing condition corresponding to the node;
a pattern acquisition step in which the pattern acquisition unit acquires a self firing pattern including one or more node identifiers determined in the transfer step;
a self accumulation step in which the self accumulation unit acquires self pattern information, using the self firing pattern acquired in the pattern acquisition step, and accumulates the self pattern information in the self storage unit; and
an output processing step in which the output processing unit performs processing, using the self pattern information in the self storage unit.

9. A non-transitory computer-readable medium storing a program for enabling a computer that can access: an NN storage unit in which neural network information is stored, the neural network information containing two or more pieces of node information each containing a node identifier, and one or more pieces of edge information each containing an edge identifier and specifying a connection between nodes; a starting point storage unit in which one or more pieces of starting point information are stored in association with a starting point condition that is a condition regarding one or more pieces of feature information of information to be accepted and that is a condition for determining a node where firing occurs without passing through other nodes, the one or more pieces of starting point information containing one or more node identifiers each specifying a node where firing occurs without passing through other nodes; a firing condition storage unit in which a firing condition is stored, the firing condition being associated with one or more pieces of node information of the two or more pieces of node information and being related to one or more pieces of feature information; and a self storage unit in which self pattern information regarding a firing pattern of self information is stored, to function as:
an information acceptance unit that accepts self information, which is information regarding oneself;
a feature acquisition unit that acquires one or more pieces of self feature information, which are feature information, from the self information;
a transfer unit that determines, from the starting point storage unit, one or more node identifiers paired with a starting point condition satisfied by the one or more pieces of self feature information acquired by the feature acquisition unit, and determines a node identifier of a node that is connected via an edge to one or more nodes that have fired and are identified by the one or more node identifiers, to which the one or more pieces of self feature information are to be transferred, and that fires based on a firing condition corresponding to the node;
a pattern acquisition unit that acquires a self firing pattern including one or more node identifiers determined by the transfer unit;
a self accumulation unit that acquires self pattern information, using the self firing pattern acquired by the pattern acquisition unit, and accumulates the self pattern information in the self storage unit; and
an output processing unit that performs processing, using the self pattern information in the self storage unit.
